(19) United States
(12) Patent Application Publication
(10) Pub. No.: US 2026/0166519 A1
(43) Pub. Date: Jun. 18, 2026

(54) AZIRIDINE OR AZETIDINE MODIFIED AMINE SORBENTS, SYSTEMS INCLUDING SORBENTS, AND METHODS USING THE SORBENTS

(71) Applicant: Global Thermostat Operations, LLC, Brighton, CO (US)

(72) Inventors: Miles Austin SAKWA-NOVAK, Arvada, CO (US); Chia-Hua TSAI, Commerce City, CO (US); Benjamin GREYDANUS, Arvada, CO (US)

(21) Appl. No.: 19/125,418

(22) PCT Filed: Dec. 8, 2023
(86) PCT No.: PCT/US2023/083220

§ 371 Date: Apr. 29, 2025

Related U.S. Application Data
(60) Provisional application No. 63/431,512, filed on Dec. 9, 2022.

(51) Int. Cl. B01J 20/26; B01D 53/04; B01J 20/28; B01J 20/32; B01J 20/34

(52) U.S. Cl. CPC B01J 20/265; B01D 53/0462; B01J 20/28045; B01J 20/3204; B01J 20/3214; B01J 20/328; B01J 20/3425; B01J 20/3483; B01D 2253/202; B01D 2253/3425; B01D 2257/504; B01J 2220/4812

(57) ABSTRACT

The present disclosure provides for sorbents and contactors, methods of using sorbents and contactors to capture CO₂, structures including the sorbent, and systems and devices using sorbents and contactors to capture CO₂. In an aspect, the present disclosure provides for sorbents that include a CO₂-philic phase and a support. The present disclosure provides for sorbents and contactors that include a CO₂-philic phase and a support, where the CO₂-philic phase includes a modified amine polymer that is the reaction product of an amine and an aziridine or azetidine

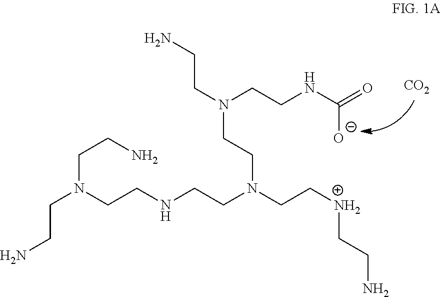

### CLAIM OF PRIORITY TO RELATED APPLICATION

This application claims priority to co-pending U.S. provisional application entitled “SORBENTS, SYSTEMS INCLUDING SORBENTS, AND METHODS USING THE SORBENTS” having Ser. No. 63/431,512 filed on Dec. 9, 2022, which is entirely incorporated herein by reference.

### BACKGROUND

Greenhouse gases trap heat in the atmosphere and carbon dioxide (CO₂) is one of the main greenhouse gases. CO₂ is emitted through human related activities such as transportation, electric power, industry and agriculture. In particular, CO₂ emissions are caused by burning fossil fuels, solid waste, and trees as well as through the manufacture of cement and other materials. One way to decrease the amount of CO₂ in the atmosphere is to capture CO₂ using materials having an affinity for CO₂. There is a need for materials that can effectively capture CO₂.

### SUMMARY

The present disclosure provides for sorbents and contactors, methods of using sorbents and contactors to capture CO₂, structures including the sorbent, and systems and devices using sorbents and contactors to capture CO₂.

In an aspect, the present disclosure provides for a sorbent comprising: a CO₂-philic phase and a support, wherein the CO₂-philic phase includes the reaction product of an amine and an aziridine or azetidine. In an aspect, the CO₂-philic phase includes a structure selected from at least one of the following structures, where Rₓ is the substituted group:

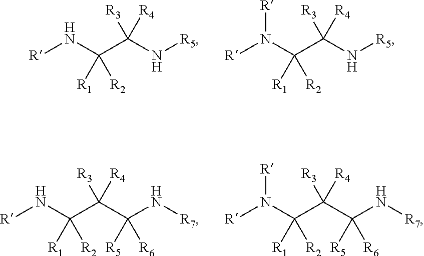

wherein R₁, R₂, R₃, R₄, R₅, R₆, and R₇ are each independently selected from a hydrogen atom, hydroxide, linear or branched alkyl, alkanol, alkoxy, alkyl halide, halide, aldehyde, ketone, carboxylic acid, ester, amine, sulfone, phosphine, aryl, aryloxy, aryl halide, benzyl, phenol, or heteroaryl and the like, and wherein each R′ are independently selected from a hydrogen atom, alkyl, alkoxy, alkyl halide, aryl, benzyl, phenyl, phenol, amine, heteroaryl, or nitroimidazole.

In an aspect, the present disclosure provides for a contactor, comprising a structure and the sorbent as described above or herein.

In an aspect, the present disclosure provides for a system for capturing CO₂ from a gas, optionally the gas is ambient air, comprising: a first device configured to introduce the gas to the sorbent or contactor as described above or herein to bind CO₂ to the sorbent; a second device configured to heat the sorbent containing bound CO₂ to at least a first temperature to release the CO₂; and a third device configured to collect the released CO₂.

In an aspect, the present disclosure provides for a method of capturing CO₂ from gas optionally the gas is ambient air comprising: introducing the ambient air to the sorbent as described above or herein to bind CO₂ to the sorbent; heating the sorbent to at least a first temperature to controllably release the CO₂; and collecting the CO₂ in a CO₂ collection device.

In an aspect, the present disclosure provides for a system for implement the method as described above or herein.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1A shows a schematic of how amine moieties bind CO₂ into the form of a carbamate.

FIG. 1B is a schematic of a sorbent system comprised of support and CO₂-philic phase. Together, the support and CO₂-philic phase comprise a sorbent.

FIG. 2 is a schematic of honeycomb monolith contactor comprised of a substrate and a sorbent washcoat.

FIGS. 3A and 3B illustrate 1H NMR spectra of PEI (FIGS. 3A and 3B, top), polymerized azetidine (FIG. 3A, middle) and 3-fluoroazetidine (FIG. 3B, middle) and PEI reacted with azetidine (FIG. 3A, bottom) and 3-fluorazetidine (FIG. 3B, bottom).

FIGS. 4A and 4B illustrate mass loss curves during exposure of sorbents created with improved CO₂-philic phases containing PEI reacted with (FIG. 4A) azetidine, and (FIG. 4B) 3-fluoroazetidine, to diluted air while ramping the temperature from room temperature to 900° C.

FIG. 5 illustrates transient mass change profiles from TGA CO₂ uptake experiments at 10% CO₂ and 6-8° C. dew point utilizing improved sorbents containing PEI reacted with azetidines, and all supported in mesoporous alumina. Data for a sorbent utilizing PEI is shown for reference as well. Data are reported as CO₂ capacity (mmol CO₂/g sorbent) and are not normalized by the variation in N content between sorbents.

FIGS. 6A-6D illustrate the extent of oxidation over time of PEI, determined via the differential scanning calorimetry method described herein and discussed in the referenced publication (solid lines, DSC), and via the loss of amine efficiency (datapoints, AE) at (FIG. 6A) 5%, (FIG. 6B) 17%, and (FIG. 6C) 30% O₂ concentration; (FIG. 6D) extent of oxidation with different PEI pore fillings. Figure taken from Nezam et al, ACS Sustainable Chem. Eng., 2021, 9, 8477-8486.

FIG. 7 illustrates transient oxidation curves for PEI and improved CO₂ sorbents containing PEI reacted with azetidines tested under 17% O₂, balance N₂ at 137.5° C., all sorbents are in mesoporous alumina.

FIG. 8 illustrates structures of aziridines and azetidines that can be reacted with an amine to form an improved CO₂-philic phase.

### DETAILED DISCLOSURE

Embodiments of the present disclosure provides for sorbents and contactors, methods of using sorbents and contactors to capture CO₂, structures including the sorbent, and systems and devices using sorbents and contactors to capture CO₂. In an aspect, the present disclosure provides for sorbents that include a CO₂-philic phase (e.g., a modified amine polymer that is the reaction product of an amine and an aziridine or azetidine) and a support. The methods, systems, sorbents, and contactors of the present disclosure can be advantageous over current technologies since they are relatively more robust and reduce the cost of capturing CO₂, in particular from ambient air. In an aspect, the present disclosure provides for sorbents having an improved CO₂-philic phase (e.g., a modified amine polymer that is the reaction product of an amine and an aziridine or azetidine) that has a greater resistance to oxidation.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, materials science, mechanical engineering, and the like, which are within the skill of the art.

The following examples are put forth so as to provide those of ordinary skill in the art with a complete disclosure and description of how to perform the methods and use the probes disclosed and claimed herein. Efforts have been made to ensure accuracy with respect to numbers (e.g., amounts, temperature, etc.), but some errors and deviations should be accounted for. Unless indicated otherwise, parts are parts by volume, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequences where this is logically possible.

It must be noted that, as used in the specification and the appended claims, the singular forms “a,” “an,” and “the” include plural referents unless the context clearly dictates otherwise. Thus, for example, reference to “a compound” includes a plurality of compounds. In this specification and in the claims that follow, reference will be made to a number of terms that shall be defined to have the following meanings unless a contrary intention is apparent.

### DISCUSSION

The present disclosure provides for sorbents (also referred to herein as “sorbent” or “sorbents”) and contactors, methods of using sorbents and contactors to capture CO₂, structures including the sorbent, and systems and devices using sorbents and contactors to capture CO₂. In an aspect, the present disclosure provides for sorbents that include a CO₂-philic phase and a support. The present disclosure is directed to multiple types of sorbents and structures that will be described below and herein.

In an aspect, the present disclosure provides for sorbents and contactors that include a CO₂-philic phase and a support, where the CO₂-philic phase includes a modified amine polymer that is the reaction product of an amine and an aziridine or azetidine, where the reaction product is also described herein. In an aspect, the modified amine polymer maintains high CO₂ capacities relative to the unmodified amine polymer. In an aspect, the sorbents with the modified amine polymer lose less of the capacity to capture CO₂ following oxidative exposures compared to sorbents created with the unmodified amine polymer, thereby creating an improved CO₂-philic phase with a longer commercial lifetime relative to CO₂-philic phase without reaction with aziridine or azetidine.

In an aspect, a modified amine polymer modified by the reaction with an aziridine or azetidine will create a CO₂-philic phase with an outer shell of amine containing moiety that can impart additional stability or productivity to the base amine polymer. This allows for the tuning of stability and productivity. Furthermore, in a sorbent (i.e., a CO₂-philic phase and a support), the amine polymer contacts the surface of a support. The reaction of the amine polymer with an aziridine or azetidine allows for the rational tuning of the outer shell of the polymer that can be specifically designed for interaction with the surface of the support.

A structured support, also referred to as a formed support or as a structure, refers to a support that has been formed into a structure where the structure is, at standard conditions, a solid body. Supports can also be unstructured, at standard conditions having a powdery consistency. When a support is referred to without mention to a structure, forming, or being formed or structured, it can refer to supports that are either structured or unstructured.

Structured supports can take the form of a homogeneous solid body (i.e., comprised predominantly of support but also containing components that allow it to remain a stable body at standard conditions) or as a coating on a substrate, whereby the substrate has a different composition than the coating and provides the mechanical stability to the coating.

It can be useful to utilize a structured support with a CO₂-philic phase as a contactor in a process for removing CO₂ from a gas stream such as ambient air. Contactors provide a geometry to a CO₂-philic phase such that considerations such as pressure drop, throughput, and/or mass transfer rates can be optimized. An active support or active structured support refers to a support or structured support containing CO₂-philic phase within the volume and/or upon the surface of its mesopores at a specific loading. The specific loading of the CO₂-philic phase is determined by the mesopore volume of the support or structured support itself and is expressed as a percentage of the mesopore volume occupied by the CO₂-philic phase. The specific loading of CO₂-philic phase may be different when the activated support, structured support, or contactor (i.e., the sorbent), each are different, or when the activated support, structured support, or contactor (i.e., the sorbent), each is deployed in a particular climate or environment. There is a need for the precise control over the level of the specific loading applied to the support.

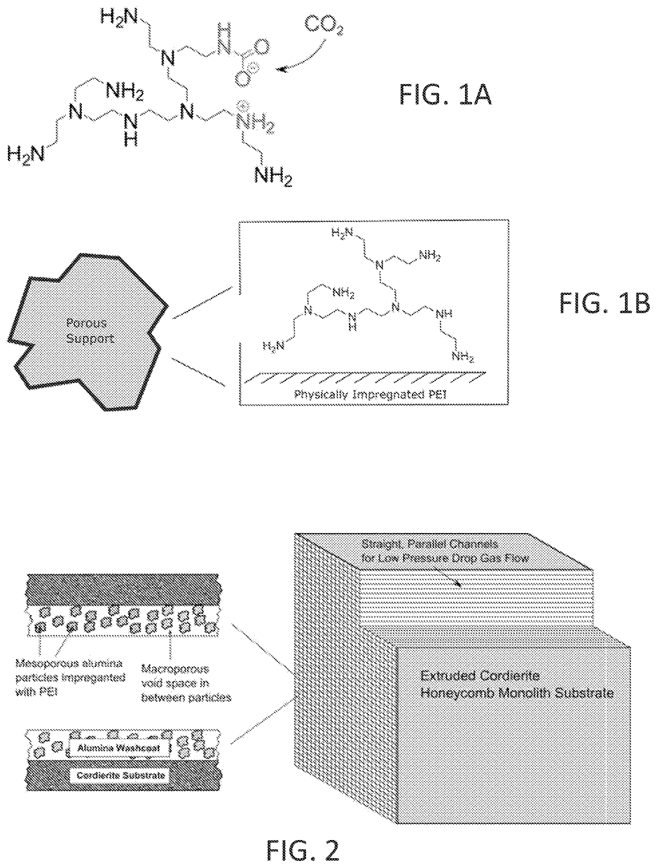

The CO₂-philic phase includes CO₂ binding molecules. The CO₂ binding molecules contain CO₂ binding moieties. The CO₂ binding molecules can be an amine or an amine polymer such as the modified amines described herein. The amine or amine polymer (e.g., used to form the modified amines and/or the modified amines) can contain primary amines, secondary amines, tertiary amines, or a mixture of any combination of primary, secondary, and tertiary amines. The amine polymer can be branched, hyperbranched, dendritic, or linear. The CO₂ binding moieties are the amine moieties on the amine molecule or polymer (e.g., modified amine). The amine moieties can interact with CO₂ to form carbamate, carbonate, or bicarbonate species. FIG. 1A shows a schematic of how amine moieties bind CO₂ into the form of a carbamate.

Primary amines are defined as having the chemical structure —NH₂R₁, where R₁ is an alkyl group such as CH₂ or CH₃. Secondary amines are defined as having the chemical structure —NHR¹R², where R¹ and R² are independently selected from an alkyl group such as CH₂ or CH₃. Tertiary amines are defined as having the chemical structure —NR¹R²R³, where R¹, R², and R³ are independently selected from an alkyl group such as CH₂ or CH₃.

Linear amine polymers can be defined as containing only primary amines, secondary amines, or both primary and secondary amines. The ratio of secondary to primary amines can be about 0.5 to 10,000. In an aspect, the linear amine polymer can have a molecular weight of about 100 to 100,000 g/mol, about 200 to 30,000 g/mol or about 600 to 5,000 g/mol.

Branched amine polymers can be defined as containing any number of primary, secondary, and tertiary amines, which does not overlap linear amine polymers or dendritic amine polymers. The ratio of primary, secondary, and tertiary can be about 10:80:10 to 60:10:30, about 60:30:10 to 30:50:20, or about 45:45:10 to 35:45:20. As one of skill would understand, the chemical structures of branched amine polymer can vary greatly and can be very complex. In an aspect, the branched amine polymer can have a molecular weight of about 100 to 100,000 g/mol, about 200 to 30,000 g/mol or about 600 to 5,000 g/mol.

Dendritic amine polymers can be defined as containing only primary and tertiary amines, where groups of repeat units are arranged in a manner that is necessarily symmetric in at least one plane through the center (core) of the molecule, where each polymer branch is terminated by a primary amine, and where each branching point is a tertiary amine. The core or central linkage is the same as the branching amines (e.g., ethylenimine core and ethylenimine branches, propylenimine core and propylenimine branches). The ratio of primary to tertiary can be about 1 to 3. In an aspect, the dendritic amine polymer can have a molecular weight of about 100 to 100,000 g/mol, about 200 to 30,000 g/mol or about 280 to 3,000.

Hyperbranched amine polymers can be defined as having chemical structure resembling dendritic amine polymer, but containing defects in the form of secondary amines (e.g., linear subsections as would exist in a branched polymer), in such a way that provides a random chemical structure instead of a symmetric chemical structure. The hyperbranched amine polymers do not overlap branch amine polymers or dendritic polymers. In a hyperbranched chemical structure, the ratio of primary to secondary to tertiary can be about 65:5:30 to 30:10:60. In an aspect, the hyperbranched amine polymer can have a molecular weight of about 100 to 100,000 g/mol, about 200 to 30,000 g/mol or about 600 to 10,000 g/mol.

In an aspect, linear, hyperbranched and branched amine polymers have secondary amines and dendritic amines do not, which may be advantageous since secondary amines bond strongly to CO₂.

In an aspect, the amine polymer can be polyethylenimine, polypropylenimine, polyallylamine, polyvinylamine, polyglycidylamine, polystyrene-divinylbenzene polymer functionalized with amine such as alkylbenzylamine moieties, or other amine polymer, where each can be branched, hyperbranched, dendritic, or linear.

In an embodiment, the size (e.g., length, molecular weight), amount (e.g., number of distinct amine polymers), and/or type of amine polymer, can be selected based on the desired characteristics of the porous support (e.g., CO₂ absorption, regenerative properties, oxidative stability, loading, and the like).

In an aspect, the modified amine polymer can contain primary amines, secondary amines, tertiary amines or a mixture of any combination of primary, secondary, and tertiary amines, each of which is defined above. The modified amine polymer can be branched, hyperbranched, dendritic, or linear, each of which is defined above.

In an aspect, the modified amine polymer can be primary or secondary before the reaction, such as to form a secondary or tertiary amine. Illustrative structures are shown below, where Rx is the substituted group:

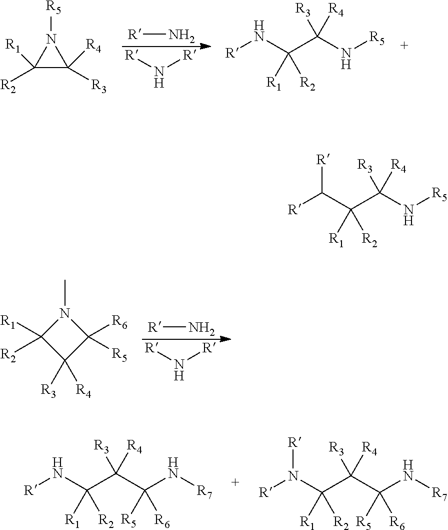

In an aspect, R₁, R₂, R₃, R₄, R₅, R₆, and R₇ can each independently be a hydrogen atom, hydroxide, linear or branched alkyl, alkanol, alkoxy, alkyl halide, halide, aldehyde, ketone, carboxylic acid, ester, amine, sulfone, phosphine, aryl, aryloxy, aryl halide, benzyl, phenol, heteroaryl and the like, and combinations thereof. In an aspect, R₁, R₂, R₃, R₄, R₅, R₆, and R₇ can each independently be linear or branched alkyl or alkyl halide. In an aspect, R₁, R₂, R₃, R₄, R₅, R₆, and R₇ can each independently be alkanol or alkoxy. In an aspect, R₁, R₂, R₃, R₄, R₅, R₆, and R₇ can each independently be aldehyde, ketone, carboxylic acid, ester, amine, sulfone, or phosphine. In an aspect, R₁, R₂, R₃, R₄, R₅, R₆, and R₇ can each independently be aryl, aryloxy, aryl halide, benzyl, phenol, or heteroaryl. In an aspect, each R′ can be independently selected from a hydrogen atom, alkyl, alkoxy, alkyl halide, aryl, benzyl, phenyl, phenol, amine (e.g., alkylenimine (C2 to C8) such as ethylenimine and propylenimine), heteroaryl, nitroimidazole, and the like, and combinations thereof. In an aspect, each R′ can be independently selected from alkyl or alkyl halide. In an aspect, each R′ can be independently selected from aryl, benzyl, phenyl, phenol, or heteroaryl. In an aspect, each R′ can be independently selected from amine (e.g., alkylenimine (C2 to C8) such as ethylenimine and propylenimine). In an aspect, each R′ can be independently selected from nitroimidazole.

In an aspect, the modification of the amine polymer by reaction with an aziridine or azetidine reduces the overall number of primary amines in the modified amine polymer system.

In an aspect, the modified amine polymer can be a modified polyethylenimine, a modified polypropylenimine, a modified polyallylamine, a modified polyvinylamine, a modified polyglycidylamine, a modified polystyrene-divinylbenzene polymer functionalized with amine such as alkylbenzylamine moieties, or other modified amine polymers, where in each the modified amine polymer can be branched, hyperbranched, dendritic, or linear.

In an aspect, the fraction of amines modified according to the description herein can be about 0.001 to 1 or about 0.01 to 1 or about 0.1 to 1 or about 0.5 to 1 of total primary and secondary amines in the amine polymer, where a fraction of 1 means all of the primary and secondary amines, or a fraction of about 0.01 to 0.5 amines in the amine polymer.

Although not intending to be bound by theory, the CO₂-philic phase modified by the reaction with the aziridines and azetidines allows for the rational introduction of substituents onto the amine polymer in order to tune the properties of the CO₂-philic phase. For example, bulky substituent groups such as phenyl or substituted phenyl can be used to sterically impede the oxygen attack during an oxidation reaction. Additionally, substituted groups can also be used to chemically stabilize the amine polymer from oxidation. Chemical stabilization can be achieved by the introduction of electron donating or withdrawing substituent groups onto the amine polymer. The amount, type, and mixture quantity of modifier can be tuned and changed to achieve the desired properties of the CO₂-philic phase. Tuning the CO₂-philic phase can result in one or a combination of the following that yield an improved CO, sorbent: increased lifetime due to a reduction in the rate of oxidative degradation, increase in amine efficiency of the sorbent, increase in the CO, swing capacity of the sorbent in an adsorption/desorption process, increase in the equilibrium capacity of the sorbent.

In an aspect, it can be advantageous to improve the stability of the CO₂-philic phase to process conditions relevant to use of the sorbent in a CO₂ separation process, particularly during sorbent regeneration (process cycles that raise the temperature of the sorbent to remove bound CO₂). It is also advantageous to improve the stability of the CO₂-philic phase to conditions relevant to storage of the sorbents when they are not being utilized in a process or plant. Sorbents that have a CO₂-philic phase with improved stability with respect to process conditions including sorbent regeneration, storage, or both process conditions including sorbent regeneration and storage are valuable.

Evaluating the oxidative stability of materials in environments that contain oxygen and CO₂ is useful due to the fact that during regeneration processes, desorbed CO₂ is present at different concentrations in addition to oxygen at elevated temperatures, and can impact the stability of the material. Separately, evaluating the oxidative stability of materials with oxygen only (air) is a useful way to evaluate the shelf life of a material when it is stored at ambient conditions.

As described above, the CO₂-philic phase (e.g., the CO₂ binding molecules) can be homogeneous or heterogeneous. When the CO₂-philic phase is heterogeneous, the CO₂ binding molecules can be present in a variety of ways. For example, the CO₂ binding molecules can be applied or incorporated to form a layer of the CO₂-philic phase on a support, such as on the surface of pores of the support. In another aspect, independent of or used in combination with other aspects such as those described above, the CO₂ binding molecules can be used to form a part of or all of the support, where CO₂-philic phase functions as described herein. Various combinations are contemplated and are part of the present disclosure. Additional ways in which to apply, use, or incorporate the CO₂-philic phase homogeneously and/or heterogeneously are described herein and below.

As described herein, the sorbent includes the CO₂-philic phase (e.g., the CO₂ binding molecules) and the support. The support includes a surface (e.g., a surface that can be exposed to a gas including CO₂ during regular use and/or that can interact with the CO₂-philic phase). The surface can be the surface of pores and/or other surfaces that the CO₂-philic phase contacts or interacts with.

In an aspect, the CO₂-philic phase (e.g., the CO₂ binding molecules) can be disposed on and/or within a support to form a sorbent. The CO₂-philic phase can be disposed on the surface of the support, and/or within pores of the support, and/or on an exterior surface of a support or any combination thereof. In an aspect, the CO₂-philic phase can be a coating on the surface of the porous material, a monolayer on the surface of the porous material, a self-assembled monolayer on the surface of the porous material, a bulk phase within the pores of the porous material, a coating on the exterior surface of the porous material, and the like.

In an aspect, the support can be made of one or more types of materials such as ceramic, metal, metal oxide, plastic, cellulose, carbon, a zeolite, a metal organic framework (MOF), a porous organic framework (POF), a covenant organic framework (COF), a polymer of intrinsic microporosity (PIM), a polymer, a fibrous cellulose, fiberglass, boron-nitride fiber, and the like. In another aspect, the support can be made of materials that also include the CO₂-philic phase.

The metal oxide support can be selected from cordierite, alumina (e.g., γ-alumina, θ-alumina, δ-alumina), cordierite-α-alumina, silica, aluminosilicates, zirconia, germania, magnesia, titania, hafnia, silicon nitride, zircon mullite, spodumene, alumina-silica magnesia, zircon silicate, sillimanite, magnesium silicates, zircon, petalite, and combinations thereof. In cases where the oxide contains a formal charge, the charge can be balanced by appropriate counter-ions, such as cations of NR₄, Na, K, Ca, Mg, Li, H, Rb, Sr, Ba, Cs or anions including phosphate, phosphite, sulfate, sulfate, nitrate, nitrite, chloride, bromide and the like. The metal oxide can contain dopants such as zirconium, iron, tin, silicon, and titanium, and combinations thereof. It is known that metal oxides can contain acid, base, and neutral sites on their surfaces and that dopants can alter the amount and strength of acid and base sites on the surfaces.

In an aspect, the polymer support can be a polymer and/or copolymer of polyolefin(s), polyester(s), polyurethane(s), polycarbonate(s), polyetheretherketone(s), polyphenylene oxide(s), polyether sulfone(s), melamine(s), polyamide(s), polyvinylbenzene, polystyrene-divinylbenzene, polyurethane, polyacrylates, polystyrenes, polyacrylonitriles, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, and agarose, or combinations thereof.

The support can be porous (e.g., macroporous, mesoporous, microporous, or mixtures thereof (e.g., where a macroporous surface can include mesopores, and/or micropores, within one or more of the macropores, where a mesoporous surface can include micropores, and so on)). In an aspect, the porous structure is mesoporous. The pores can extend through the porous structure or porous layer or only extend to a certain depth. The macropores of the porous structure can have pores having a diameter of about 100 nm to 10,000 nm, a length of about 500 nm to 100,000 nm and a volume of 0.2-1 cc/g. The mesopores of the porous structure can have pores having a diameter of about 5 nm to 100 nm, a length of about 10 nm to 10,000 nm, and a volume of 0.1-2 cc/g. The micropores of the porous structure can have pores having a diameter of about 0.5 to 5 nm, a length of about 0.5 nm to 1000 nm and a volume of about 0.1-1 cc/g.

The support can be porous and have a porosity of at least 90%, at least 85%, at least 80%, at least 75%, at least 70%, at least 65%, at least 60%, or about 60 to 90%. In some embodiments, the support can have a surface area of about 1 m²/g or more, about 10 m²/g or more, about 100 m²/g or more, about 150 m²/g or more, about 200 m²/g or more, or about 250 m²/g or more, about 500 m²/g or more, about 1000 m²/g or more.

In an embodiment, the CO₂-philic phase (e.g., the CO₂ binding molecules) can be physically impregnated in the internal volume pores of the porous structure and not covalently bonded to the internal surface of the pores of the porous structure, can be grafted (e.g., covalently bonded directly or indirectly) to the internal surface of the pores of the porous structure, or a combination thereof. In an embodiment, the CO₂-philic phase (e.g., the CO₂ binding molecules) can be covalently bonded (e.g., directly to the surface or via a linker group) to the surface of the material, which may include the internal surface of pores for a porous layer or porous structure. In an aspect, the covalent bonding can be achieved using known techniques in the art for bonding sorbents. In regard to the CO₂-philic phase (e.g., the CO₂ binding molecules) being physically impregnated in the pores of the porous structure and not covalently bonded to the internal surface of the pores of the porous structure, the CO₂-philic phase can be confined within the pores of the support, but not be bonded to the surface. In yet another embodiment, the CO₂-philic phase (e.g., the CO₂ binding molecules) is present in a plurality of pores (internal volume) of the porous structure (“porous structure” can include a structure having pores in its surface or a structure having a porous layer or coating on the surface of the structure (where the structure itself may or may not be porous)), where the CO₂-philic phase has a loading of about 10% to 75% by weight of the support. In regard to the loading, the loading is determined by thermogravimetric analysis (TGA).

In an embodiment, the support can include a surface layer on the surface of the pores of the support that can bond with the CO₂-philic phase. In an aspect, the surface layer can include organically modified moieties (e.g., alkyl groups, amines, thiols, phosphines, and the like) on the surface (e.g., outside and/or inside surfaces of pores) of the material. In an embodiment, the surface layer can include surface alkyl groups, amines, thiols, phosphines, and the like, that the CO₂-philic phase can directly covalently bond and/or indirectly covalently bond (e.g., covalently bond to a linker covalently bonded to the material). In an embodiment, the surface layer can include an organic polymer having one or more of the following groups: alkyl groups, amines, thiols, phosphines, and the like. In another embodiment, the structure can be a carbon support, where the carbon support can include one or more of the following groups: alkyl groups, amines, thiols, phosphines, and the like.

In an embodiment, the CO₂-philic phase can have a specific loading of about 10 to 100% of the mesopore volume of the support, or can have a specific loading of about 30 to 90% of the mesopore volume of the support, or can have a specific loading of about 40 to 80% of the mesopore volume of the support, or can have a specific loading of about 50 to 70% of the mesopore volume of the support.

The process of making a structured support, formed support or structure described above and herein can be used to create any of the structures listed in this paragraph and those in the following paragraphs. The sorbent, comprising the CO₂-philic phase and the support, can be formed into or applied to a structure. In an aspect, the CO₂-philic phase and the support can form 100% of the structure or less than 100% (e.g., each combination of ranges between about 10%, about 20%, about 30%, about 40%, about 50% and about 60%, about 70%, about 80%, about 90%, about 99% such as about 10-99%, about 10 to 80%, about 10 to 50%, about 50 to 99%, about 50 to 90%, about 50 to 80%), where a sufficient amount of sorbent is on the surface of the structure to absorb the desired amount of CO₂. In an aspect, the structure can be a honeycomb, a laminate sheet, a foam, fibers, minimal surface solids, powder trays, pellets, powder, and the like or a combination of two or more of the foregoing.

In an aspect, the porosity of the structure can be comprised of macropores, mesopores, and/or micropores. In an aspect, the CO₂-philic phase is predominantly (e.g., about 40 to 100% or about 50 to 90%, or about 60 to 80%) located within the mesopores of the structure.

In an aspect, the structure can be comprised entirely of sorbent or can contain another substrate material such as ceramic, metal, metal oxide, plastic or another material. The structure can be a porous substrate and can also include a porous coating on some or all parts of the porous substrate, where the CO₂-philic phase can be present in the pores of one or both of the porous substrate and the porous coating.

When the structure is comprised entirely of sorbent (e.g., CO₂ binding molecules and a support), it can be formed by extrusion, molding, 3D printing, and the like, for example. The structure can be formed using support material without the CO₂-philic phase or using the support with the CO₂-philic phase already incorporated. When formed without using the CO₂-philic phase, the CO₂-philic phase can be incorporated into the structure through an impregnation, grafting, or other functionalization technique.

In a particular aspect, the support material can be applied to a substrate as a porous coating (also referred to as a “washcoat”) on the surface of the substrate. In an embodiment, the porous coating can be a foam such as a polymeric foam (e.g., polyurethane foam, a polypropylene foam, a polyester foam, and the like), a metal foam, or a ceramic foam. The porous coating can include a metal-oxide layer (e.g., such as a foam). The metal-oxide layer can be silica or alumina on the surface of the substrate, for example. The porous coating can be present on the surface of the substrate, within the pores or voids of the substrate, or a combination thereof. The porous coating can be about 50 μm to 1500 μm thick and the pores can be of the dimension described above and herein.

In an aspect, the support material, the substrate, and/or the structure can be made of a ceramic substrate such as cordierite, alumina (e.g., γ-alumina, θ-alumina, δ-alumina), cordierite-α-alumina, silica, aluminosilicates, zirconia, germania, magnesia, titania, hafnia, silicon nitride, zircon mullite, spodumene, alumina-silica magnesia, zircon silicate, sillimanite, magnesium silicates, zircon, petalite, and combinations thereof. The metal or metal oxide structure can be aluminum, titanium, stainless steel, a Fe—Cr alloy, or a Cr—Al—Fe alloy. In cases where the oxide contains a formal charge, the charge can be balanced by appropriate counter-ions, such as cations of NR₄, Na, K, Ca, Mg, Li, H, Rb, Sr, Ba, Cs or anions including phosphate, phosphite, sulfate, sulfate, nitrate, nitrite, chloride, bromide and the like.

In an aspect, the support material, the substrate, and/or the structure can be made of a plastic substrate that can be made of a polymer and/or copolymer of polyolefin(s), polyester(s), polyurethane(s), polycarbonate(s), polyetheretherketone(s), polyphenylene oxide(s), polyether sulfone(s), melamine(s), polyamide(s), polyvinylbenzene, polystyrene-divinylbenzene, polyurethane, polyacrylates, polystyrenes, polyacrylonitriles, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, and agarose, or combinations thereof.

In an embodiment, the structure can be a honeycomb structure such as a honeycomb monolith structure that includes channels. The honeycomb structure can have a regular, corrugated structure. The honeycomb monolith structure can have a length and width on the order of centimeters to meters while the thickness can be on the order of millimeters to centimeters or more. In an aspect, the honeycomb monolith structure does not have fibrous dimensions. In other words, the honeycomb structure can be a flow-through substrate comprising open channels defined by walls of the channels. The channels can have about 50 to about 900 cells per square inch. The channels can be polygonal (e.g., square, triangular, hexagonal, octagonal) sinusoidal, circular, or the like, in cross-section. Along the length of the channel, the channel length can have a configuration that is straight, zig-zag, skewed, or herringbone in shape. The length of the channel can be 1 mm to 10s or 100s of cm or more. The channels can have walls that are perforated or louvered. In an aspect, the sorbent can be disposed in the pores of the honeycomb structure and/or in the pores of a porous layer on the surface of the honeycomb structure. The honeycomb structure can have a geometric void fraction, otherwise known as the open face area, of between 0.3 to 0.95 or about 0.5 to 0.9.

In an embodiment, the honeycomb structure can comprise an inlet end, an outlet end, and inner channels extending from the inlet end to the outlet end. In some embodiments, the honeycomb comprises a multiplicity of cells extending from the inlet end to the outlet end, the cells being defined by intersecting cell or channel walls.

In an aspect, the honeycomb structure and/or substrate can be ceramic (e.g., of a type produced by Corning under the trademark Celcor®) that can be used with the sorbent in accordance with the principles of the present disclosure. The sorbent can be coated or otherwise immobilized on the inside of the pores of the ceramic honeycomb structure and/or within a porous layer on the surface of the ceramic honeycomb structure. In an aspect, the porous coating can include a metal-oxide layer such as silica or alumina on the surface of the substrate. In an embodiment, the metal-oxide layer can be mesoporous and macroporous. The honeycomb monolith may have a depth of 3 inches to 10 feet or about 3 and 24 inches.

In an aspect, the structure can be laminate sheets. Laminate sheets are structures containing a one-dimensional wall structure, whereby sheets are stacked upon one and other with space in between each sheet such that gas can flow between the sheets.

In an aspect, the structure can be a foam. Foams are structures with an irregular channel structure surrounded by an irregular solid structure. The solid structure is interconnected such that the foam material is self-standing.

In an aspect, the structure can be a plurality of fibers. Fibers are structures with high aspect ratio, and in gas contacting applications can be arranged in a regular array amongst one another when supported at least on one end of the fiber. The fibers can be solid or hollow.

In an aspect, the structure can be a minimal surface solid. Minimal surface solids are structures often used in packing for distillation and absorption systems to increase contact area with a material and a fluid. Minimal surface area solids are geometries that have zero mean surface area and include shapes such as gyroids. Gyroids can be sinusoidal, for example.

In an aspect, the structure can be a powder tray. Powder trays are structures whereby trays hold loose powder or pellets of the sorbent of the present disclosure to form a structured contactor without the material forming a self-standing structure by itself. Powder trays can be arranged in stacked layers to form sheets thereby forming a structure similar to a laminate. These layers can be created using flexible sheets, stiff sheets, or other flat surface that is mounted on a stiff frame structure. Powders are loose, free flowing solids with small characteristic particle diameter such as to provide a powdery consistency. Pellets are beads, balls, or other compacted structures used to provide structure and surface area to sorbents.

In an aspect, the structure can be sorbent particle volumes. Sorbent particle volumes can be contained by one or more walls such that gas can pass through them while keeping the sorbent contained. Sorbent particle volumes can be arranged relative to other sorbent particle volumes such as to approximate a honeycomb, fiber, or other structured contactor with a solid body.

In an aspect, the sorbent (e.g., structure) in the form of a contactor is an efficient embodiment for an effective method for capturing CO₂ from ambient air or other gas mixtures (e.g., flue gas, exhaust gas, natural gas, or other gasses containing CO₂) because a structured contactor, or a contactor, can be engineered to provide high surface area and low pressure drop for the air processing. Contactors can take the forms described of a honeycomb, a laminate sheet, a foam, fibers, minimal surface solids, powder trays, pellets, powder, and the like or a combination of two or more of the foregoing.

Now having described embodiments of the sorbent and structure, details regarding the systems and methods of the present disclosure are provided. The present disclosure provides for methods of capturing CO₂ from ambient air or other gas mixtures (e.g., flue gas, exhaust gas, natural gas, or other gasses containing CO₂). The method includes introducing the ambient air to the sorbent (e.g., structure), heating the sorbent (e.g., about 10 to 200° C. above the regular sorbent temperature to absorb the CO₂) to at least a first temperature to controllably release the CO₂; and collecting the CO₂ in a CO₂ collection device. The temperature increase in the sorbent can be performed by contacting the sorbent with a gas at elevated temperature, contacting the sorbent with a fluid at an elevated temperature, contacting the sorbent with a heat exchanger with hot fluid or gas running through it, by heating the walls of the container, vessel, or other containment device that contains the sorbent, or by contacting the sorbent with steam (e.g., the steam may be at a temperature between 60 to 200° C., and be saturated or superheated). In an aspect, the method can be implemented using the system described below.

The present disclosure provides for systems and devices for capturing CO₂ from ambient air or other gas mixtures (e.g., flue gas, exhaust gas, natural gas, or other gasses containing CO₂) where removal of CO₂ is important. In general, the system includes a first device configured to introduce the ambient air or other gas mixture to the sorbent or contactor, where the sorbent or contactor includes those described herein. The sorbent is exposed to the ambient air or other gas mixture for a period of time (e.g., hours). In a particular aspect, the sorbent is a honeycomb monolith that has an open face area of between 0.3-0.95. The first device is configured to deliver the ambient air, for example, to the honeycomb monolith at a velocity of between 0.25-10 m/s. After the desired amount of time, a second device configured to heat the sorbent containing bound CO₂ to at least a first temperature to release the CO₂. The second device of the system can operate to desorb CO₂ by the sorbent. The second device can include components to support temperature swing, pressure swing, steam swing, concentration swing, combinations thereof, or other dynamic processes to desorb the CO₂. In an embodiment, the steam swing process can include exposing the sorbent to steam, where the temperature of the steam is about 60° C. to 150° C. and the pressure of the steam is about 0.2 bara to 5 bara. A third device is configured to collect the released CO₂. The system can be operated so that the sorbent absorbs and desorbs the CO₂ in an efficient and cost-effective manner.

### EXAMPLES

The removal of CO₂ from ambient air through engineered chemical processes, otherwise known as Direct Air Capture (DAC), is emerging as an important environment technology for the mitigation of climate change. DAC is a technology that can provide negative emissions, removing CO₂ from the atmosphere. However, the current DAC technology is expensive thereby limiting its deployment. Therefore, improvements to DAC technology are needed. Many DAC technologies rely on solid sorbent materials as a medium to perform the separation of CO₂ from the air. These sorbents are generally applied in temperature swing processes, where at low temperature CO₂ from the air binds to the sites within them, and then at high temperature the CO₂ is released into a concentrated product that can be sequestered or sold as a product. Many DAC sorbents utilize amines to bind CO₂ in this manner. Certain amine types can be effective at binding CO₂ from low concentrations such as that found in the air (400 ppm).

While some amine types are effective at binding CO₂ from ambient air, they slowly oxidize in air from ambient oxygen. This effect is exacerbated in process cycles that raise the temperature of the sorbent to remove bound CO₂, thereby creating accelerated oxidative degradation that reduces the lifetime of the CO₂ sorbents. Therefore, sorbents with improved oxidative stability that are effective at removing CO₂ from ambient air are needed.

Some sorbents used in DAC processes are composite materials, containing a CO₂-philic phase (e.g., CO₂ binding molecules) that is distributed in or within a solid material that provides it with surface area. The CO₂-philic phase can be grafted to the solid surface, physically impregnated into the pores of the solid material, or physically supported on the surface of the solid material. The CO₂-philic phase of these sorbents can be amines or other molecules that can bind CO₂. In some cases, the amines can be polymeric amines such as polyethylenimine, polypropylenimine, polyallylamine, polyvinylamine, polybutylamine or others. These polymeric amines can be linear, branched, hyperbranched, dendritic, or take the form some other macromolecule. In other cases, the amines can be small molecules such as TEPA, TPTA or others. In other cases, the amines can be aminosilanes. The solid support material can be a metal oxide, carbon, metal, or other structure that can provide ample surface area for the CO₂-philic phase to be deposited to allow for useful CO₂ adsorption and desorption capacities and kinetics. In this way, the solid support material is functionalized with the CO₂-philic phase to create a composite sorbent.

The sorbents can be formed or incorporated into macrostructures, or contactors, to provide advantages in applications such as DAC. Such structures can be honeycomb monoliths, laminate sheets, pellets, or other structures that can provide a high geometric surface area for air or CO₂ containing gasses to efficiently contact the sorbent such that the CO₂ can bind to the sorbent.

The sorbents can be utilized in processes to capture CO₂ from air or a variety of other gas stream such as flue gas, natural gas and others. These processes are known as “CO₂ Capture Processes”. CO₂ capture processes can utilize temperature swing, concentration swing, pressure swing, steam stripping or other swing techniques to remove CO₂ that has been bound the surface of the sorbent.

There has been relatively little development of improved CO₂ sorbents utilizing polyethylenimine, and especially for DAC applications.

Now having described the embodiments of the present disclosure, in general, the following examples describes some additional embodiments of the present disclosure. While embodiments of the present disclosure are described in connection with these examples and the corresponding text and figures, there is no intent to limit embodiments of the present disclosure to these descriptions. On the contrary, the intent is to cover all alternatives, modifications, and equivalents included within the spirit and scope of embodiments of the present disclosure.

### Example: Schematic Showing Sorbent Having a Support Material and CO₂-Philic Phase

FIG. 1B shows the primary components of the sorbent system. The sorbent system is comprised of a support material and a CO₂-philic phase. In the schematic shown, a single CO₂-philic phase is shown incorporated into a single support. The CO₂-philic phase shown is polyethylenimine (PEI). One known adsorption product of CO₂ and PEI is ammonium carbamate. Mesoporous alumina is shown as a support.

### Example: Schematic of Honeycomb Monolith Structure Containing a Sorbent Washcoat

FIG. 2 shows one embodiment of a honeycomb monolith contactor. FIG. 2 shows the primary geometrical features of a honeycomb monolith, having straight, flowthrough channels surrounded on all sides by walls. FIG. 2 schematically shows a washcoat applied to the walls, where the washcoat is comprised of sorbent. The sorbent is comprised of a support material and a CO₂-philic phase, such as PEI. This example shows a cordierite substrate, an alumina support, and a PEI CO₂-philic phase.

### Example: Preparation of 3-fluoroazetidine

The azetidine 3-fluoroazetidine was prepared by stirring 1.1155 g of 3-fluoroazetidine hydrochloride with 3.322 eq of NaOH (1.3286 g) in 1.5 ml water at room temperature for 30 min, followed by vacuum distillation at room temperature to obtain 0.75 g of 3-fluoroazetidine (99.9% yield).

### Example: Preparation of Improved CO₂-Philic Phase Containing Polyethylenimine (PEI) Reacted with Azetidines

Branched PEI MW 800 is available from Sigma Aldrich. The azetidines are azetidine and 3-fluoroazetidine.

PEI Reacted with Azetidine:

The PEI (0.2 g) was dissolved in a solution of methanol, after which 0.2 g azetidine was added, followed by 0.094 mL of 70% HClO₄. The mixture was allowed to stir at 80° C. for 70 h to allow the azetidine to react with the PEI. The solvent of the reaction mixture was removed, after which 30 mL Ambersep 900 and 10 mL water were added. The reaction mixture was then allowed to stir at room temperature for 24. Subsequently, the Ambersep 900 was removed via filtration, and the filtrate was condensed and dried under vacuum at 50° C. for >12 h. The resulting polymer is referred to as PEI-b-PPI.

PEL Reacted with 3-Fluoroazetidine:

The PEI (0.2 g) was dissolved in a solution of methanol, after which 0.2 g 3-fluoroazetidine was added, followed by 0.07 mL of 70% HCIO4. The mixture was allowed to stir at 80° C. for 90 h to allow the azetidine to react with the PEI. The solvent of the reaction mixture was removed, after which 30 mL Ambersep 900 and 10 mL water were added. The reaction mixture was then allowed to stir at room temperature for 24 h. Subsequently, the Ambersep 900 was removed via filtration, and the filtrate was condensed and dried under vacuum at 50° C. for >12 h. The resulting polymer is referred to as PEI-b-F-PPI.

Impregnation into a Porous Support:

Separately, the azetidine reacted PEI was dissolved in methanol and mixed until homogenous. Next, mesoporous alumina was dispersed in the azetidine reacted PEI solution. After stirring for >5 h, the solvent was removed by rotary evaporation and subsequent drying in a vacuum oven at 50° C. for >12 h. Mass ratios of the alumina and azetidine reacted PEI were controlled such as to achieve 40-80% filling of the mesopores of the mesoporous alumina with azetidine reacted PEI. The resultant composite sorbents were of a powdery consistency.

### Example: Characterization of Improved CO₂-Philic Phases and CO₂ Sorbents

Chemical characterization was carried out to confirm the properties of the supports, and the improved CO₂-philic phases. Further chemical characterization was carried out to confirm that these CO₂-philic phases were successfully incorporated into the pores of a mesoporous support to create an improved CO₂ sorbent.

¹H NMR experiments were carried out on PEI and the materials resulting after reaction of PEI with various azetidines to characterize the nature of the resultant material.

TGA burnoff experiments were carried out on sorbents comprised of the improved CO₂-philic phases and the mesoporous support to characterize the total quantity of organic present in the sorbent. Samples were heated under diluted air to 900° C. and their mass loss tracked. Total organic content was taken as the mass loss over that temperature interval, after removing the contribution of CO₂ and H₂O lost at lower temperatures.

### Example: ¹H NMR Spectra of PEI and Improved CO₂-Philic Phases Created by Reaction of PEI with Azetidines

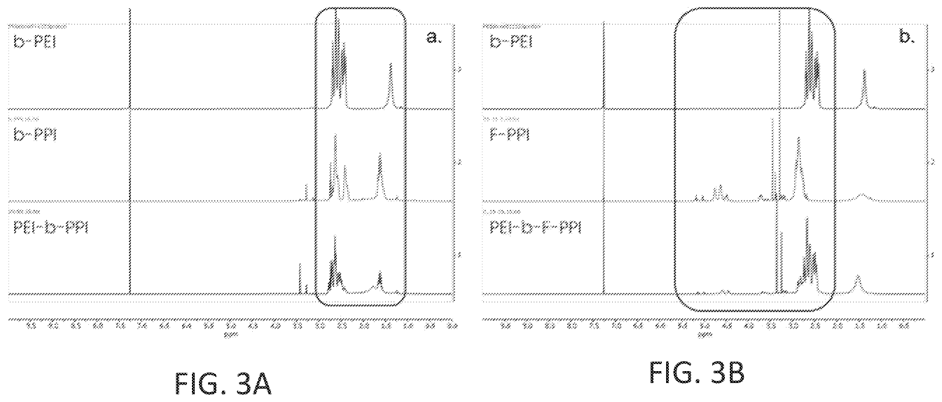

FIGS. 3A and 3B illustrate ¹H NMR spectra of PEI reacted with azetidine and 3-fluoroazetidine as well as comparisons to unmodified PEI and the individual azetidines polymerized. In comparing the spectra, peaks from PEI and b-PPI or b-F-PPI are observed in the resulting reacted polymers PEI-b-PPI and PEI-b-F-PPI, suggesting that the synthesis was successful and the desired product was achieved.

### Example: TGA Burnoff Experiments

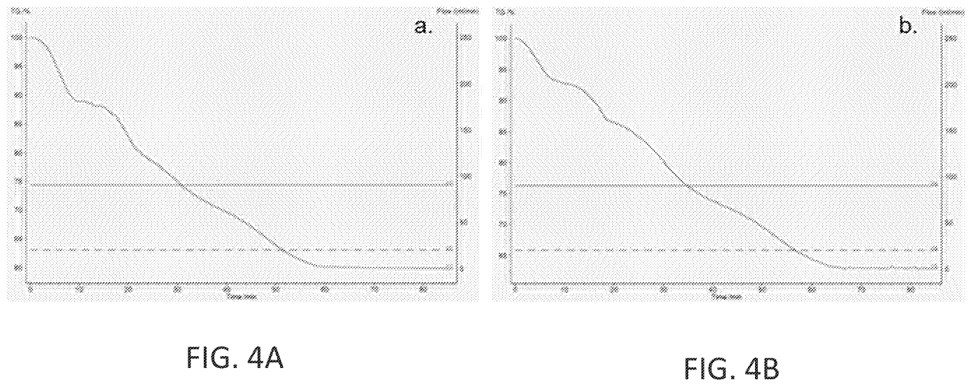

FIGS. 4A and 4B show the mass loss curve during exposure of materials to diluted air while ramping the temperature from room temperature to 900° C. The resulting organic loadings of the materials are as follows: PEI-b-PPI—31.7%, PEI-b-F-PPI—31%.

### Example: Testing in CO₂ Adsorption Processes

Sorbents created with improved CO₂-philic phases were tested for CO₂ adsorption in a TGA under 10% CO₂ at 30° C. and humidity at a dew point of 6-8° C. to evaluate the effectiveness of the sorbents for capturing CO₂. The sorbents were first treated in N₂ at 100° C. to desorb any bound H₂O and CO₂ before being equilibrated at 30° C. under humidified N₂. Then, the gas concentration was switched isothermally to contain humidified 10% CO₂ balanced by N₂ and the mass change was recorded. To humidify the N₂ and 10% CO₂ balance N₂ gases, the gas was saturated with water vapor at a dew point of 6-8° C. by sparging the gas stream in a water bath held at the corresponding temperature. Under these humid conditions, it is assumed that no additional water is adsorbed between switching from a humidified N₂ stream to a humidified CO₂ and N₂ stream, and thus the mass gain of the material corresponds to the adsorption of CO₂ and therefore can be used to measure the total quantity and rate of CO₂ adsorption onto the materials.

Various improved sorbents were characterized for CO₂ adsorption using this method, and compared to the baseline PEI based sorbent. The sorbents were evaluated based on their CO₂ capacity, mmol of CO₂ adsorbed per mol of sorbent present.

### Example: CO₂ Adsorption Uptake Capacities at 10% CO₂ of PEI and Improved CO₂-Philic Phases Supported on Mesoporous Alumina

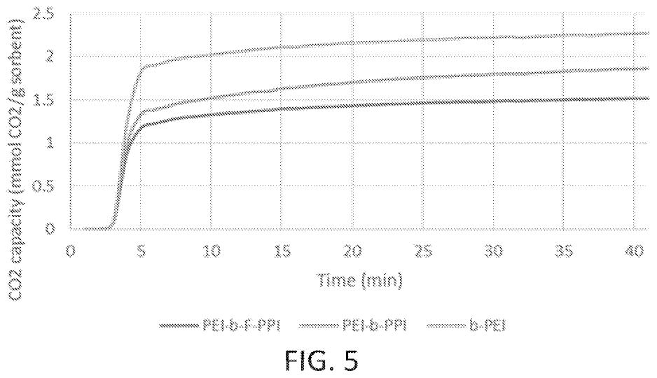

FIG. 5 shows transient TGA CO₂ uptake curves for sorbents created with improved CO₂-philic phases utilizing PEI reacted with azetidine (PEI-b-PPI, 50.8% pore fill), and 3-fluoroazetidine (PEI-b-F-PPI, 49% pore fill), compared to that of unmodified PEI (54% pore fill). Each of the sorbents are able to adsorb CO₂ with varying degrees of performance.

### Example: Testing of Oxidative Stability

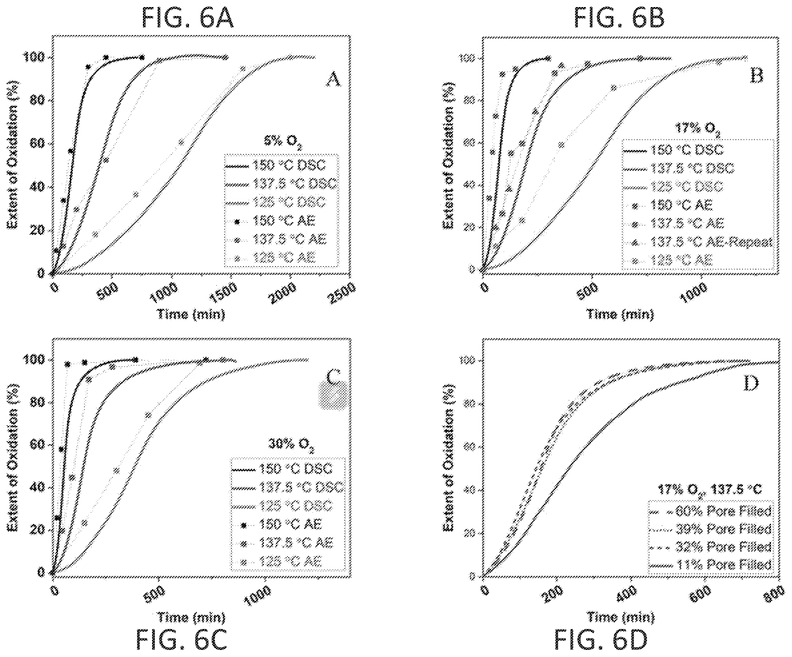

The oxidative stability of materials can be probed in several ways In this study, the oxidative stability of the sorbents was evaluated by tracking the heat flow evolved from the materials using a DSC during exposure to isothermal oxidative conditions. Here, the sorbents were first treated in inert gas at 100° C. to desorb any bound H₂O and CO₂ before being equilibrated at 137.5° C. under inert gas for 60 minutes. The gas was then isothermally switched to a 17% O₂ mixture and held until the reaction finished. This isothermal, oxidative environment was maintained for a specific amount of time to measure the heat flow and mass loss. To prevent any further oxidation, the sample was then cooled under N₂ to room temperature. During these experiments, for each oxidative condition, the DSC measures the incremental heat flux, which increases, levels out, and then decreases to zero. The oxidation was considered complete when the integrated heat flow over 10 min changed less than ±0.01% of the total integrated heat. To determine the extent of oxidation as a function of time, DSC data were converted from the base unit of mW/mg sorbent to W/gPEI using the PEI loading measured by TGA burnoff. DSC data were corrected for drift by applying an offset, determined by the heat flow value when the DSC curve approached a horizontal line. The total heat evolved was calculated by integrating heat flow over time. The extent of oxidation from DSC was calculated by dividing the integral heat flow curve by the total heat evolved. This method has been previously calibrated with the loss in amine efficiency as being a method of tracking the chemical reaction rate of oxidative degradation in-situ, and is shown in FIG. 6. Further details on this method and its validation are discussed in the following papers: Nezam et al, ACS Sustainable Chem. Eng., 2021, 9, 8477-8486, and Racicot et al, J. Phys. Chem. C, 2022, 126, 8807-8816, which is incorporated herein by reference.

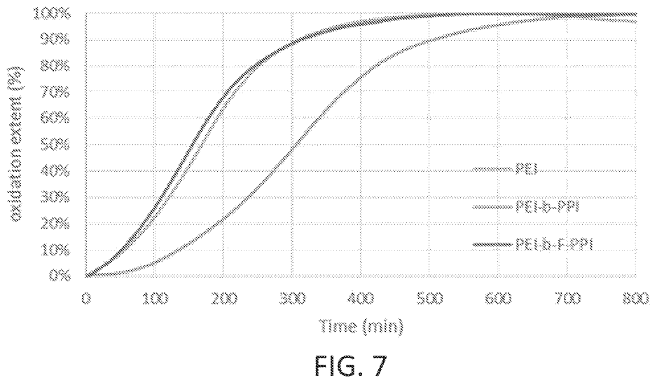

FIG. 7 shows oxidation curves in the presence of air only for improved CO₂ sorbents utilizing PEI reacted with azetidine (PEI-b-PPI) and 3-fluoroazetidine (PEI-b-F-PPI), compared to that of unmodified PEI, supported in mesoporous alumina. It can be seen that azetidine reacted PEI can maintain (PEI-b-F-PPI), or increase (PEI-b-PPI) the oxidative stability of PEI when compared to the unmodified PEI. This suggests that certain azetidines can be effective for improving the oxidative stability of amine polymer sorbents.

### Example

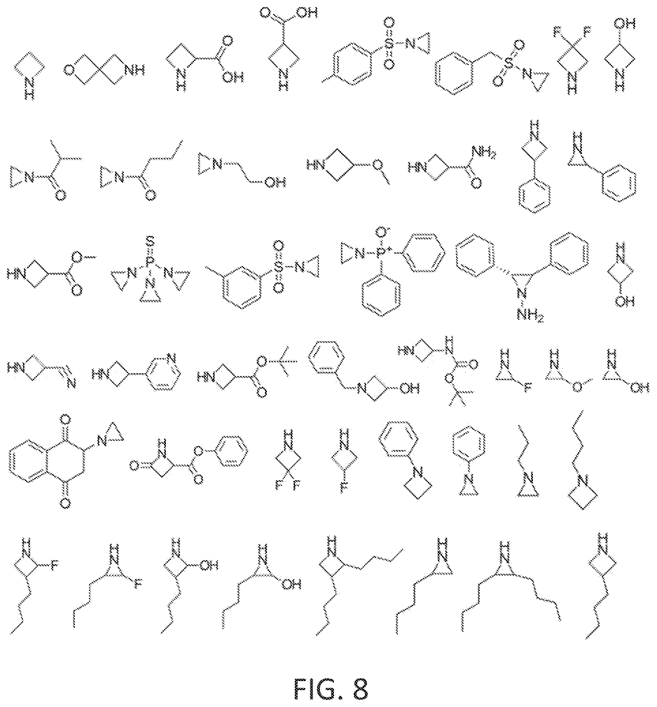

FIG. 8 illustrates structures of aziridines and azetidines that can be reacted with an amine to form an improved CO₂-philic phase.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, “about 0” can refer to 0, 0.001, 0.01, or 0.1. In an embodiment, the term “about” can include traditional rounding according to significant figures of the numerical value. In addition, the phrase “about ‘x’ to ‘y’” includes “about ‘x’ to about ‘y’”.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A composition comprising:
a CO₂-philic phase, wherein the CO₂-philic phase includes a reaction product of an amine and an aziridine or azetidine, wherein the reaction product has a molecular weight of 200 to 5,000 g/mol.

2. The composition of claim 1, wherein the amine is an amine polymer.

3. The composition of claim 2, wherein the amine polymer is branched, hyperbranched, dendritic, or linear.

4. The composition of claim 3, wherein the amine polymer is one of polyethylenimine, polypropylenimine, polyallylamine, polyvinylamine, polyglycidylamine, or polystyrene-divinylbenzene polymer functionalized with amine.

5. The composition of claim 1, wherein the CO₂-philic phase is homogenous.

6. The composition of claim 1, wherein the CO₂-philic phase is heterogeneous.

7. The composition of claim 1, wherein a fraction of amines modified by reaction with the aziridine or azetidine is about 0.001 to 1 of total primary and secondary amines in the amine polymer, where a fraction of 1 means all of the primary and secondary amines.

8. The composition of claim 1, wherein a fraction of amines modified by reaction with the aziridine or azetidine is about 0.01 to 0.5 of total primary and secondary amines in the amine, where a fraction of 1 means all of the primary and secondary amines.

9. The composition of claim 1, wherein the amine is physically impregnated into pores of a support.

10. The composition of claim 1, wherein the amine is physically impregnated onto a surface of a support.

11. The composition of claim 1, wherein the amine is covalently bonded to a surface of a support.

12. The composition of claim 1, wherein the CO₂-philic phase includes a structure selected from at least one of the following structures, where Rₓ is a substituted group: 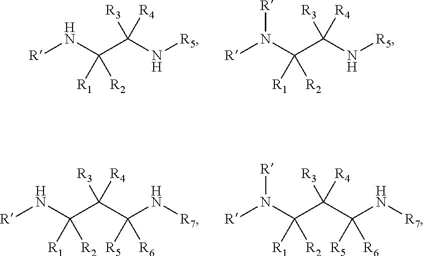
wherein R₁, R₂, R₃, R₄, R₅, R₆, and R₇ are each independently selected from a hydrogen atom, hydroxide, linear or branched alkyl, alkanol, alkoxy, alkyl halide, halide, aldehyde, ketone, carboxylic acid, ester, amine, sulfone, phosphine, aryl, aryloxy, aryl halide, benzyl, phenol, or heteroaryl, and wherein each R′ is independently selected from a hydrogen atom, alkyl, alkoxy, alkyl halide, aryl, benzyl, phenyl, phenol, amine, heteroaryl, or nitroimidazole.

13. The composition of claim 1, wherein the composition is disposed on a support, and wherein the support comprises a ceramic, a metal, a metal oxide, a plastic, cellulose, carbon, a zeolite, a metal organic framework (MOF), a porous organic framework (POF), a covenant organic framework (COF), a polymer of intrinsic microporosity (PIM), a polymer, a fibrous cellulose, fiberglass, or boron-nitride fiber.

14-15. (canceled)

16. A system for capturing CO₂ from a gas, the system comprising:
a first device configured to introduce the gas to a sorbent to bind CO₂ to the sorbent, wherein the sorbent comprises a CO₂-philic phase, wherein the CO₂-philic phase includes a reaction product of an amine and an aziridine or azetidine, and wherein the reaction product has a molecular weight of 200 to 5,000 g/mol;
a second device configured to heat the sorbent containing the bound CO₂ to at least a first temperature to release the bound CO₂; and
a third device configured to collect the released CO₂.

17. The system of claim 16, wherein after being heated the sorbent is regenerated so that it is able to capture additional CO₂ from the gas.

18-20. (canceled)

21. The system of claim 16, wherein the system is configured to operate to remove CO₂ from ambient air, where the ambient air has a low concentration of CO₂.

22-27. (canceled)

28. The composition of claim 1, wherein the composition is disposed on a support.

29. The composition of claim 28, wherein the support is selected from a honeycomb, a laminate sheet, a foam, a fiber, a minimal surface solid, a powder tray, a pellet, or a combination thereof.

30. The composition of claim 29, wherein the honeycomb has an open face area of about 0.3-0.95.

31. The composition of claim 1, wherein the CO₂-philic phase is dissolved in a solvent.
